(19) United States
(12) Patent Application Publication
(10) Pub. No.: US 2025/0100319 A1
(43) Pub. Date: Mar. 27, 2025

(54) FINGER ATTACHING WRITING INSTRUMENT

(71) Applicant: GOUDOUKAISYA TOYAKOHATSUMEI, Sagamihara-shi, Kanagawa (JP)

(72) Inventors: Tetuei LI, Sagamihara-shi (JP); Seigen LI, Sagamihara-shi (JP)

(73) Assignee: GOUDOUKAISYA TOYAKOHATSUMEI, Sagamihara-shi, Kanagawa (JP)

(21) Appl. No.: 18/576,891

(22) PCT Filed: Jun. 15, 2022
(86) PCT No.: PCT/JP2022/024999

§ 371 Date: Jan. 5, 2024

(30) Foreign Application Priority Data
Sep. 24, 2021 (JP) 2021-172704

(51) Int. Cl. B43K 23/012

(52) U.S. Cl. CPC B43K 23/012

(57) ABSTRACT

In a finger attaching instrument turnably coupled to a finger attaching tool attached between a second joint and a root joint of an index finger and used while alternatively changing it in a writing posture and a holding posture, the finger attaching writing instrument having excellent functionality is provided. The tail portion of the writing instrument is provided to be short so as not to protrude from the root joint of the index finger in the writing posture. When changing the posture, the tail portion is pressed with the thumb to turn it in the opposite direction, and then it is used. In the holding posture, the tail portion is closer to the second joint of the index finger, and the shaft body is placed on the web between the index finger and the thumb.

### TECHNICAL FIELD

The present invention relates to a finger attaching writing instrument in which each time when simultaneously performing works such as writing, panel operating or keyboard inputting, the works can be alternately performed while the writing instrument is attached to a finger without the need to hold or place the writing instrument each time.

The writing instrument described above is not only a writing instrument such as a pencil and a ballpoint pen, but also a writing instrument in a wide sense showing a rod-like shape, including a touch pen, an electrodynamic pen and an electronic pen, and the writing includes not only the act of writing (drawing) characters, marks, pictures and the like, but also data sensing and panel operating.

### BACKGROUND OF THE INVENTION

When the writing and another work are alternatively performed, it is inefficient and cumbersome to repeat holding and placing the writing instrument each time. In addition, if the writing continues for a long time, pain and fatigue due to pressure on the fingers are easily caused. A number of writing instruments and holders that can be attached to the fingers and hands have been disclosed in order to make the fingers comfortable and improve work efficiency.

### PRIOR ART DOCUMENT

### Patent Documents

[Patent Document 1] U.S. Pat. No. 5,850,352
[Patent Document 2] U.S. Pat. No. 4,528,350

### Outline of the Invention

### Problems to be Solved by the Invention

Although both of the above-described prior arts are disclosed by the applicant, the two prior arts have one structural commonality. In both cases, the direction of the writing instrument in the holding posture is the same as that in the writing posture, and the writing instrument is provided parallel to the index finger. The reason for this common structure is due to the preconception that it would be most convenient to provide the writing instrument in the holding posture in the same forward direction as the writing posture and parallel to the index finger, considering the easy operation by the thumb and the distance between the postures.

In addition to the prior arts mentioned above, most of the writing instruments and holders disclosed in order to solve the same problem up to now are based on such a common ground, so it can be called common sense.

However, based on this common sense, if the writing instrument is attached to the index finger and the direction of the writing instrument in the holding posture is set in the same forward direction as the writing posture, the following problems will become unavoidable. Since the nib of the writing instrument in the holding posture protrudes over the tip of the index finger and interferes with other work, how to move the writing instrument forward or rearward or retract the writing instrument; how to orient or stabilize the writing instrument in the two postures; and how to easily change the posture. In other words, it is a means of moving the writing instrument forward or backward, retracting, orienting, stabilizing, and posture changing.

The above-mentioned patent documents 1 and 2 provide mechanical means such as sliding of the writing instrument by gravity, the extending and retracting arm, the gear, housing the shaft body, the double structure, and folding of the shaft body, in order to solve these problems. Therefore, the present invention provides a new technology that reverses conventional sense without providing the means such as the sliding, the extending and contracting arms, the gear, the housing, the double structure, and the folding.

### Means for Solving Problems

Hereinafter, major means for solving the problem of the present invention will be described.

As a result of repeated testing while experimenting with various shapes and structures for many years, the present invention has discovered a series of phenomena that reverses the common sense described above, and based on the know-how acquired through the discovery and testing, it has been possible to establish a revolutionary means for obtaining more excellent effects than before. In a word, the revolutionary means is to provide a coupling part with a finger attaching tool at a place where the shaft body touches the index finger in the writing posture. Then, the tail portion on the rear side of the coupling part is made as short as possible, the tail portion of the writing instrument is operated with the thumb to change the posture, and the writing instrument is turned rearward in the holding posture, and the writing instrument is held on the Kokou (the web between the thumb and the index finger). Then, this means will be described in detail.

(1) First, the finger attaching tool coupling part of the writing instrument is provided at a place approximately 9 to 10 centimeters away from the nib of the writing instrument in the length direction of the writing instrument as a reference value. This is to ensure the required length of the writing instrument in the standard writing posture, because the place where the shaft body touches the index finger is about 9 to 10 centimeters on average away from the nib of the writing instrument in a holding posture of an adult, and the portion on the rear side of the place is not related to the writing posture or the holding of the pen. (See FIG. 1.)

(2) Then, the tail portion on the rear side of the coupling part of the writing instrument is provided as short as possible. If the writing instrument coupling part provided on the finger attaching tool is provided by extending from the ring shaped part, the extended part is also provided as short as possible. The specific standard is provided so that the tail portion of the writing instrument in the writing posture is positioned in front of the root joint of the index finger without exceeding the root joint. If the position of the tail portion of the writing instrument exceeds the index finger root joint, it is difficult to operate it since the position exceeds the range where the thumb can easily move, and the turning of the writing instrument is also hindered. (See FIG. 1, FIG. 2 and FIG. 10.)

(3) If you put your thumb on the short tail portion and lightly push it down, it becomes possible to instantly turn the entire writing instrument in the opposite direction with the slight force of your thumb. It is easy to think that the turning the entire writing instrument is exaggerated in the imagination, but in fact, it is different from the imagination, it is sensitive to even a slight force, and it ends easily. Then, so far from seeming a large motion, in fact, since it ends much more easily than retracting or extending after making the shaft body parallel to the index finger, it is phenomena that reverses the common sense. The same is true when turning it from the rearward to the forward. (See FIG. 2 and FIG. 3.)

(4) Unless you consciously extend your fingers straight in the shape of a human hand, the four fingers other than the thumb are naturally slightly bent toward the thumb. When changing to the writing posture, if you lightly press the tail portion of the writing instrument downward with your thumb in the natural state, the index finger on which the writing instrument is attached goes up a little in the opposite upward direction reflexively, so that the space between the index finger and the middle finger becomes wider, and the turned writing instrument abuts just between the first joint and the second joint of the middle finger depending on the degree of inclination and then stops, so if you bring your thumb and the index finger close to it, the perfect writing posture is achieved. (See FIG. 3 and FIG. 4.)

(5) When changing from the writing posture to the holding posture, if the tail portion of the writing instrument is lightly pressed downward with the thumb, the writing instrument is turned rearward, and the shaft body is just placed on the kokou (the web between the thumb and the index finger) according to the degree of inclination, and it is changed to the holding posture. In the holding posture, the tail portion of the writing instrument is attached to the index finger via the coupling part, and the long shaft body is placed across the kokou. As for the shape of the kokou, the hard and large root joint of the index finger protrudes on the right side, and the root joint of the thumb is on the left side, so it has a soft and concave triangular shape like a valley between them, so that the action of natural stopper of the shape is also added, and the writing instrument does not easily fall or move away from the kokou and is stabilized even if the hand is lowered down, the arm is bent, or the first is clenched. (See FIG. 2, FIG. 4, FIG. 5, FIG. 6 and FIG. 7.)

(6) In an attaching way and attaching position of the finger attaching tool, in a case where the writing instrument coupling part provided on the finger attaching tool is formed by extending from the ring-shaped part, the length of the portion of the writing instrument protruding in front of the index finger in the writing posture changes depending on whether the extended portion is attached forward or rearward. In addition, the length of the writing instrument can also be adjusted to a certain extent by attaching the finger attaching tool to the finger and then moving it forward and rearward between the second joint and the root joint of the index finger. In this case, the extended portion of the finger attaching instrument is attached forward, and the closer it to the second joint of the index finger is, the longer the writing tool in the writing posture becomes, and the writing instrument takes a standing posture. On the other hand, the extended portion of the finger attaching tool is attached rearward, and the closer it to the root joint of the index is, the shorter the protruded portion of the writing instrument toward the tip of the finger becomes, and the writing instrument takes a lateral posture. (See FIG. 11.)

(7) In an angle of the writing instrument in the writing posture, when the attaching position of the finger attachment tool is on the side surface of the index finger and then the writing instrument is turned in parallel with the index finger, the turning trajectory of the writing instrument naturally becomes parallel with the index finger, but when it is attached on the side lower surface of the index finger, the turning trajectory of the writing instrument becomes inclined. The closer the attaching position of the finger attaching tool to the lower surface of the finger is, the greater the degree of the inclination becomes. Although the above-mentioned (4) and (5) have been grasped since before, by shortening the tail portion of the finger attachment tool in the present invention, a more obvious inclination forming effect has been obtained. (See FIG. 12.)

(8) With a series of discoveries and know-how described above, when the tail portion of the writing instrument is provided short, the thumb is placed on the tail portion of the writing instrument, and the direction of the writing instrument is turned in the opposite direction to change the posture, various effects which are completely different from common sense and imagination and which have never been achieved before are obtained.

### Effect of Invention

(1) The optimum length of the writing instrument is realized without the extending and retracting means. When the writing instrument is held in parallel with the index finger and in the same direction as the writing posture, because the writing instrument protrudes toward the tip of the finger in the holding posture, and therefore the means for extending and retracting the writing instrument is necessary. However, in the present invention, because the tail portion of the writing instrument is shortened and the writing instrument is turned rearward in the holding posture, the short tail portion is on the front side and is parallel with the second joint of the index finger, and no portion protrudes forward, and the optimum holding posture is thus obtained without providing the extending and retracting means. Then, when changed to the writing posture, since the long shaft body originally provided corresponding to the writing posture is on the front side and it returned to the original writing posture, it is not need to extend the writing instrument. By turning the writing instrument forward and rearward, a more complete solution is realized than the most excellent extending and retracting means.

(2) The orientation and stability of the writing instrument are realized without providing the orientation and stability means. First, the present invention can perform adjustment in a number of ways according to the angle and the length of the writing instrument in the writing posture by the attaching direction and the attaching position of the finger attaching tool. In addition, when changed from the holding posture to the writing posture, the shaft body is naturally placed on the area near between the first joint and the second joint of the middle finger, and when the index finger and the thumb are closer to the area, the writing posture is naturally achieved, so that the writing posture can be formed without providing the angle, orientation, or stabilizing means. In addition, when changed to the holding position, the writing instrument is turned rearward, and the shaft body is paced on the kokou between the index finger and the thumb to be stabilized. Therefore, it did not disturb other work, and the orientation and stabilization function are realized without separately providing the orientation and stabilization means.

(3) The operation remarkably becomes simple. Since the present invention does not provide means such as a locking function, an advancing/retreating function, an extending/retracting function, an orientation and stabilizing function of the writing instrument, the movement of the thumb to operate such functions is also not required. The operation for changing the posture of the writing instrument does not require turning the finger, pulling, lifting, or pushing, and it requires only one movement for touching only the tail portion of the writing instrument with the thumb and then push it downward with the thumb in the same manner in both the postures, which makes the operation more simple than it could be.

(4) Hand feeling becomes good. Since the tail portion of the writing instrument is supported by the index finger, the finger does not get tired even when writing for a long time, the pressure on the middle finger is released, and the hand and finger become comfortable. This is a basic essential function of a finger attaching writing instrument or holder. However, in the present invention, in particular, any functional means is not provided, under a condition where the feeling of holding an ordinary writing instrument is maintained, only the rear portion of the writing instrument is held by the finger, the user feels the writing instrument very lightly, the angle and the inclination in the writing posture can be adjusted suitably, and especially, in the holding posture, the portion protruding to the tip of the finger is completely eliminated, which makes it easy to carry out other work, and the shaft body is placed on the kokou and the finger can hardly feel a load so that the feeling for the hand is very improved.

(5) Low cost and wide versatility are achieved. The present invention does not provide mechanical means such as sliding, gear, extending and retracting arm, double structure, housing of the shaft body, folding and the others, as in the prior art, and solves the problem by the simplest structure. Therefore, if the extending and retracting means and the stabilizing means may be added, they are easily added based on the present invention. So, the present invention is easy to be used in industry. By changing the nib and contents of the writing instrument, the present invention can be applied to a touch pen for finger attachment, an electronic pen for finger attachment, a data reading pen, and the others so that the versatility is wide.

### BRIEF DESCRIPTION OF DRAWINGS

FIG. 1 is a side view showing an outline of a finger attaching writing instrument of Example 1

FIG. 2 is a side view showing the position of the writing instrument in the holding posture of Example 1.

FIG. 3 is a side view showing the turning trajectory of the writing instrument at the time of changing the posture of Example 1

FIG. 4 is a front view showing the relationship between the length of the writing instrument and the grip way of the pen in the writing posture of Example 1.

FIG. 5 is a side view showing a state of the writing instrument when the hand is raised in the holding position of Example 1.

FIG. 6 is a side view showing a state of the writing instrument when the hand is lowered in the holding position of Example 1.

FIG. 7 is a side view showing a state of the writing instrument when the hand is clenched in the holding position of Example 1.

FIG. 8 is a side view showing the writing instrument to which a pencil is attached, in Example 2.

FIG. 9 is a side view showing the attachable and detachable finger attaching writing instrument of Example 3.

FIG. 10 is a side view of the finger attaching tool having a writing instrument coupling part extended from a ring shaped part.

FIG. 11 is a diagram showing the relationship between the finger attaching position and the degree of inclination in the writing posture.

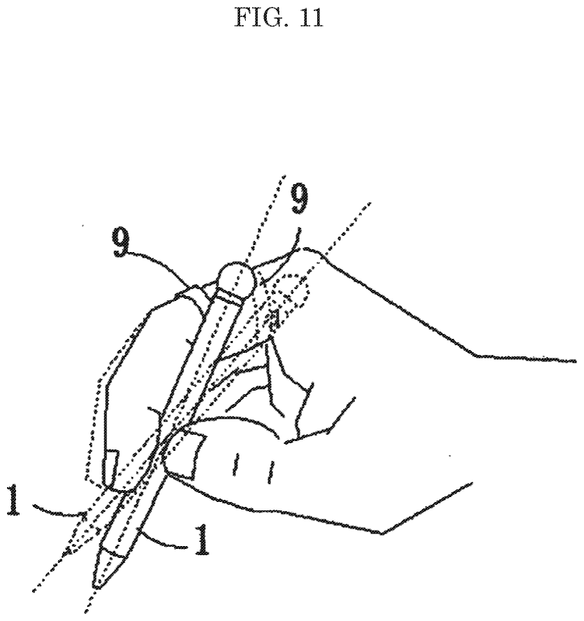

FIG. 12 is a diagram showing the relationship between the attaching position of the finger attaching tool and the angle of the writing posture in the writing posture.

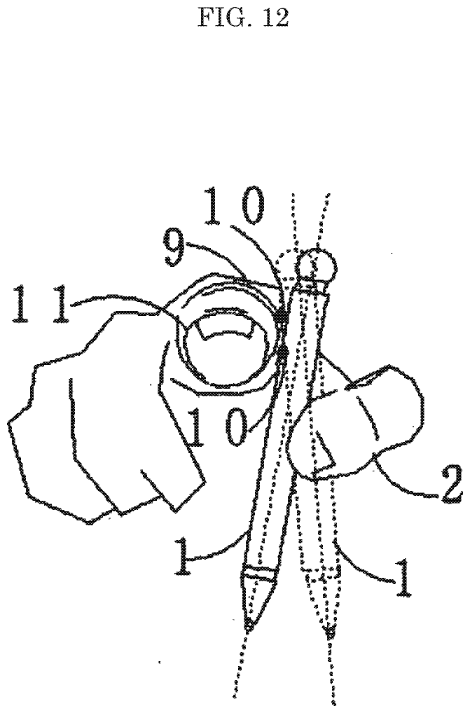

### MODE FOR CARRYING OUT THE INVENTION

First, a finger attaching tool will be described. The finger attaching tool is for attaching a writing instrument to a finger, and has a finger attaching function and a writing instrument coupling function. To provide a ring shape or provide elasticity deformable in a ring shape, it can be usable regardless of the thickness of the finger. The coupling part can be attached and detached using a magnet or the like. The coupling part is directly provided in the ring shape. When the coupling part is provided by extending or protruding from the ring shaped part, it is necessary to provide the extended portion as short as possible so as not to affect the operation of the thumb.

Next, a writing instrument will be described. The shape of the writing instrument is the same rod shape as a general writing instrument for finger attachment, and the content of the writing instrument contains the necessary component such as a brush core and a mechanism for protruding the core in the case of a general writing instrument, and electronic components in the case of an electronic pen. A finger attaching tool coupling part is provided on the shaft body of the writing instrument at a place in contact with the index finger in the writing posture. The finger attaching coupling part may be fixed to the shaft body, and may be movable or separatable from it. The tail portion behind it is provided as short as possible.

The present invention is formed as described above, and when used, the finger attaching tool is attached between the second joint and the root joint of the index finger, and is used while changing in between the writing posture and the holding posture. The present invention will be described in detail with reference to the embodiments and drawings.

### EXAMPLE 1

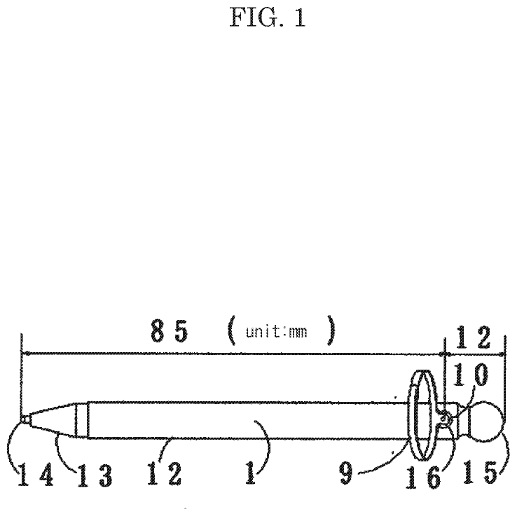

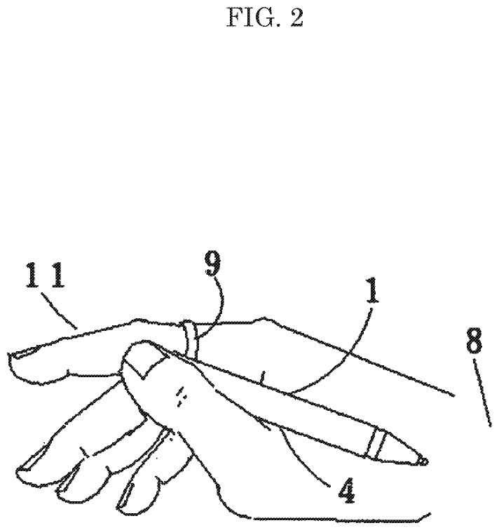

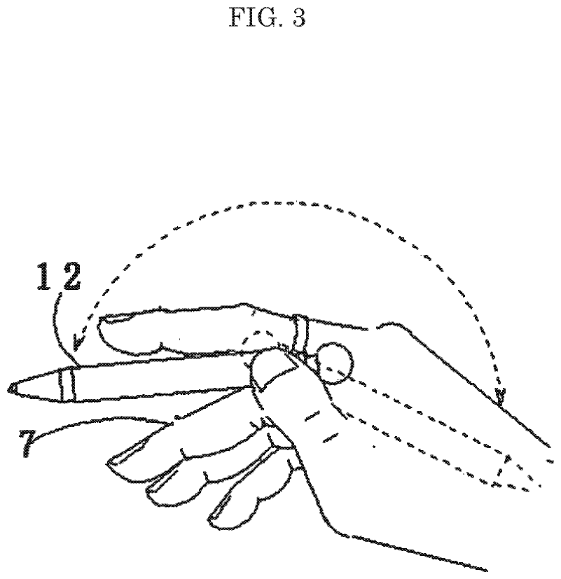

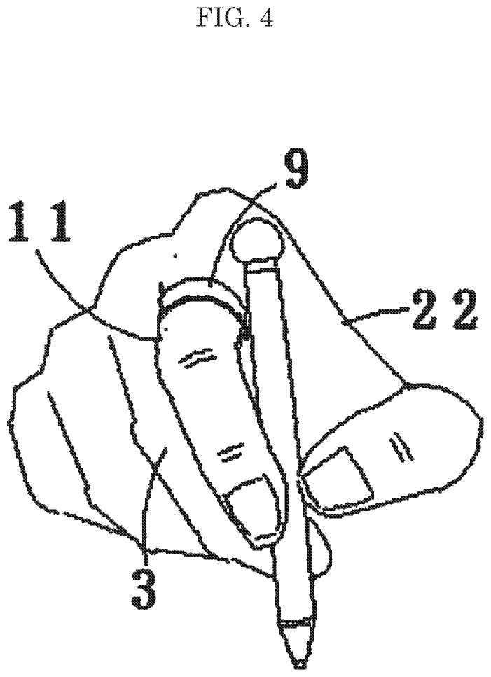

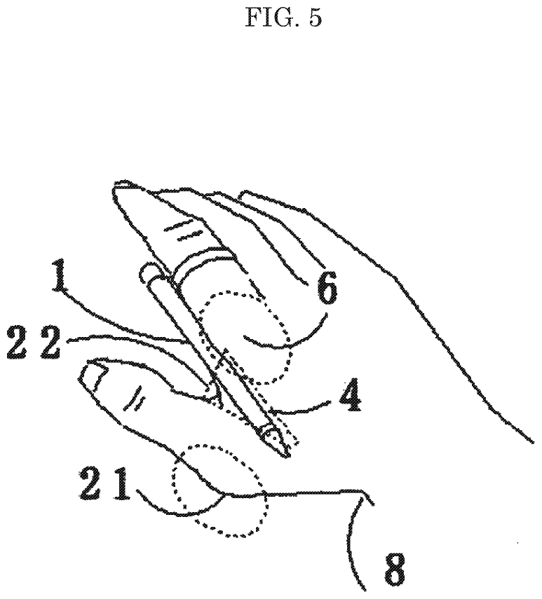

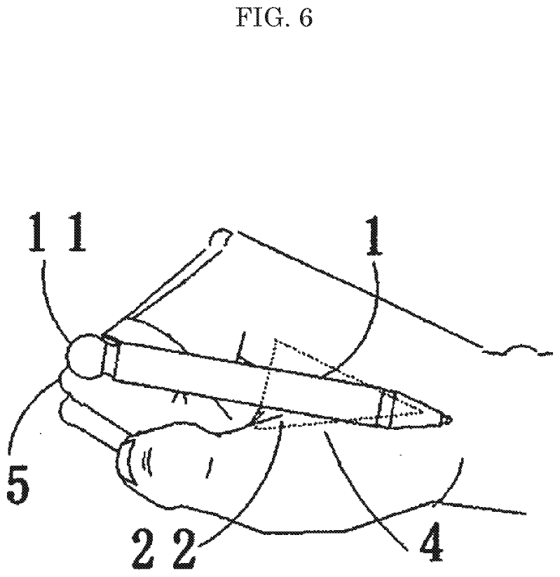

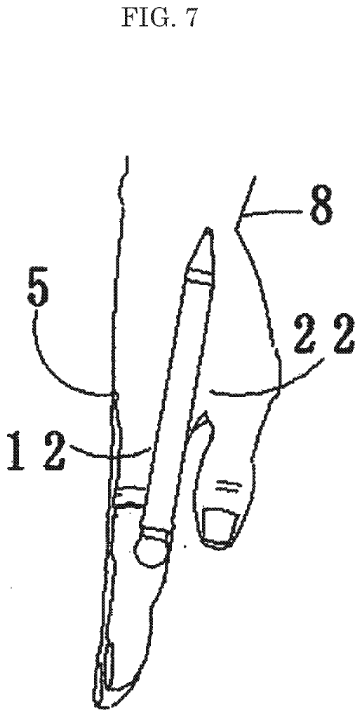

Example 1 shows a finger attaching ballpoint pen of the present invention. FIG. 1 to FIG. 7 are related views of Example 1. A writing instrument 1 is connected to a ring-shaped finger attaching tool 9 in a turnable manner. The writing tool 1 is formed of a large nib 13, a core 14, a shaft body 12, a tail portion 15, a finger attaching tool coupling part 16 and the others. The finger attaching tool 9 is made of soft synthetic resin having a predetermined elasticity and thus has elasticity. The length of the writing instrument from the tip to the coupling part is 85 mm, the length of the tail portion 15 is short as 12 mm, and the tail portion 15 is designed to be spherical in order to improve the feeling of the operation of the thumb 2.

When this example is used, the finger attaching tool 9 is attached between the second joint 5 of the index finger and the root joint 6 of the index finger. The direction of the writing tool 1 may be forward or rearward, but when the writing instrument 1 is attached so as to face the wrist 8, the short tail portion 15 is forward and lines up next to the second joint 5 of the index finger, and the long shaft body 12 is placed on the kokou 4 to be in the holding postured. In the holding posture, since there is no object protruding in front of the second joint 5 of the index finger, the hand and the finger are easily moved, the tail portion 15 is held to the index finger 11 via the finger attaching tool 9, and moves together with the index finger 11, and the shaft body 12 is placed on the kokou 4 by gravity without falling and separating, so that other work can be performed freely.

When changing from the holding posture to the writing posture, the thumb 2 is placed on the tail portion 15 and then presses it downward without turning the thumb 2. As a result, the writing instrument 1 is instantly turned around the coupling part by centrifugal force, and the shaft body 12 comes into contact with near the first joint 7 of the middle finger and stops, so that when the index finger 11 and the thumb 2 are brought close to it and grasps it, the writing posture is naturally formed. In the writing posture, as the coupling part of the finger attaching tool 9 is positioned on the lower surface of the index finger 11, the degree of inclination of the writing instrument 1 after the turning becomes large, and on other hand, as the coupling part of the finger attaching tool 9 is positioned on the side surface from the lower surface of the index finger 11, the degree of inclination of the writing instrument 1 becomes small. Further, the closer the attaching position of the finger attaching tool 9 to the root joint 6 of the index finger is, the shorter the length of the writing instrument 1 protruding over the finger becomes, and the writing instrument 1 takes a lateral posture. On the other hand, the closer the attaching position to the second joint is, the longer the length of the writing instrument 1 protruding over the finger becomes, and the writing instrument 1 takes an upright posture. Therefore, the inclination degree and angle can be adjusted suitably.

When changing from the writing posture to the holding posture, the thumb 2 is placed on the tail portion 15 and lightly presses it, and it is turned around the coupling part to be returned to the original holding posture. The work for replacing the core 14 of the writing instrument 1 is performed by rotating the large nib 13.

### EXAMPLE 2

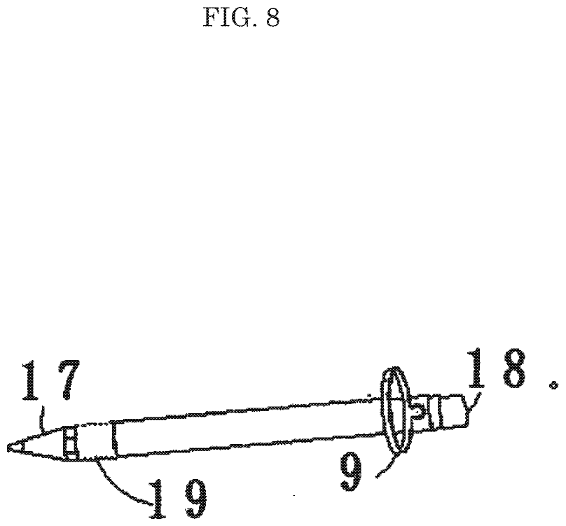

FIG. 8 shows Example 2. Example 2 is a finger attaching pencil, and the tail portion 18 is an eraser. A special pencil or a pencil having a length of about 10 centimeters can be attached from the tightening opening 19, and used until its end while pulling out it little by little. It can also be used as a teaching tool for students and children. The posture changing operation is the same as in Example 1.

### EXAMPLE 3

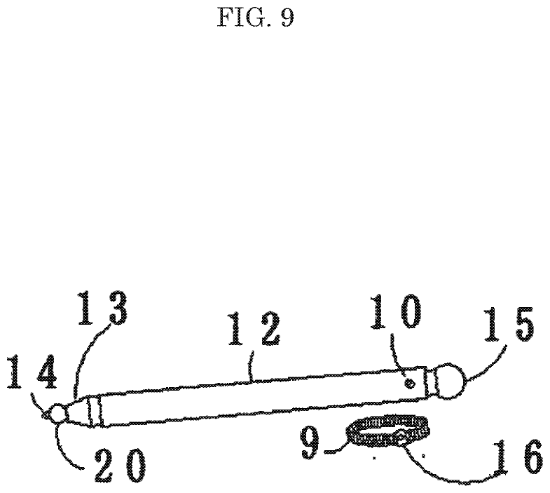

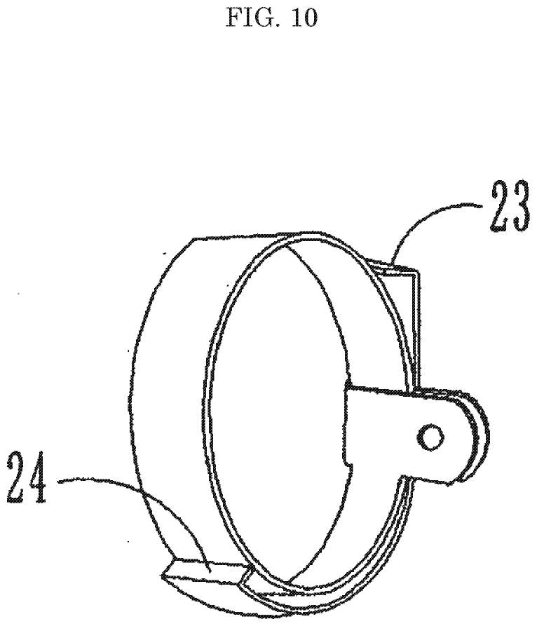

FIG. 9 shows Example 3. In the Example 3, the two functions of a touch pen and a ballpoint pen are combined, and the large nib 13 is made of a material generating static electricity to be formed in a small spherical shape. In the writing posture, the large nib 13 is rotated in the left and right directions to allow the core 14 of the ballpoint pen to be extended from or retracted into the shaft body 12. The finger attaching tool 9 is formed in a belt-like spring, a small doughnut-like magnet is provided in the writing instrument coupling part 10, and a protruding magnetized metal body is provided in the finger attaching tool coupling part 16 of the writing instrument 1, thereby making the writing instrument attachable and detachable. When it is not used, only the body of the writing instrument 1 can be removed and transported while the finger attaching tool 9 is attached to the finger. The posture changing operation and others are the same as in Example 1. FIG. 10 is a ring developed for a finger attaching tool dedicated for the present invention. By using elasticity of stain less material, when the upper blade part 23 and the lower blade part 24 are pressed downward at the same time with the finger, the aperture of the ring can be changed.

### INDUSTRIAL AVAILABILITY

The rod-shaped various digital pens can be attached to the finger using the technique of the present invention, regardless of a conventional writing instrument such as a ballpoint pen and a pencil, so that the wide industrial availability and practicability can be obtained.

1. A finger attaching writing instrument in which the writing instrument is coupled to a finger attaching tool in a turnable manner, the finger attaching tool is attached between a second joint and a root joint of an index finger of a user on a side facing a thumb, and the writing instrument is used while alternatively changing it in a writing posture and a holding posture, wherein
a tail portion of the writing instrument is provided to be short so as not to protrude from the root joint of the index finger in the writing posture,
a posture changing operation is performed only by moving the thumb of the hand to which the writing instrument is held, and
in the holding posture, the tail portion of the writing instrument faces forward toward a finger tip of the hand to which the writing instrument is held while a nib faces rearward toward a wrist of the hand.

2. The finger attaching writing instrument according to claim 1, in which the writing instrument is coupled to the finger attaching tool in a turnable manner, the finger attaching tool is attached between the second joint and the root joint of the index finger of the user, and the writing instrument is used while alternatively changing it in the writing posture and the holding posture, wherein
the panel operating function or the data reading function is provided,
the tail portion of the writing instrument is provided to be short so as not to protrude from the root joint of the index finger in the writing posture,
the posture changing operation is performed only by moving the thumb of the hand to which the writing instrument is held, and
in the holding posture, the tail portion of the writing instrument faces forward toward the finger tip of the hand to which the writing instrument is held while the nib faces rearward toward the wrist of the hand.

3. The finger attaching writing instrument according to claim 1, in which the writing instrument is coupled to the finger attaching tool in a turnable manner, the finger attaching tool is attached between the second joint and the root joint of the index finger of the user, and the writing instrument is used while alternatively changing it in the writing posture and the holding posture, wherein
the tail portion of the writing instrument is provided to be short so as not to protrude from the root joint of the index finger in the writing posture,
the posture changing operation is performed only by moving the thumb of the hand to which the writing instrument is held, and
in the holding posture, the tail portion of the writing instrument faces forward toward the finger tip of the hand to which the writing instrument is held while the nib faces rearward toward the wrist of the hand.
